(19) United States
(12) Patent Application Publication
(10) Pub. No.: US 2023/0359225 A1
(43) Pub. Date: Nov. 9, 2023

(54) SYSTEM FOR ASSISTING TRACKING OF A WAKE VORTEX FOR AIRCRAFTS

(71) Applicant: Airbus SAS, BLAGNAC (FR)

(72) Inventors: Clément FROT, BLAGNAC (FR); Guillaume TA, BLAGNAC (FR); Jordan Lee ADAMS, BLAGNAC (FR)

(21) Appl. No.: 18/310,014

(22) Filed: May 1, 2023

(30) Foreign Application Priority Data
May 3, 2022 (FR) 2204183

(51) Int. Cl. G05D 1/10

(52) U.S. Cl. CPC G05D 1/104

(57) ABSTRACT

A system for assisting formation flight, on board a follower aircraft, determines an estimated position of a wake vortex generated by a leader aircraft and inducing an upward airflow. The system determines a first trajectory, intended to be followed by the follower aircraft, as a trajectory for approaching and tracking the wake vortex, while remaining outside a potential discomfort window. The system determines a second trajectory corresponding to a phantom aircraft as if the follower aircraft is permanently in an optimal position relative to the wake vortex. The system assesses future overshoots of the phantom aircraft relative to maneuvering capabilities of the follower aircraft and to passenger comfort rules. The system possibly modifies the first trajectory as a function of the assessed overshoots.

### CROSS-REFERENCES TO RELATED APPLICATIONS

This application claims the benefit of French Patent Application Number 2204183 filed on May 3, 2022 the entire disclosure of which is incorporated herein by way of reference.

### FIELD OF THE INVENTION

The present invention relates to a system for assisting tracking of a wake vortex for aircraft. More specifically, the present invention relates to a system for anticipating disturbances generated by a wake vortex (also called marginal vortex), particularly during a formation flight.

### BACKGROUND

Wake vortices, also called marginal vortices or wingtip vortices, are counter-rotating wake turbulence at the wingtips of an aircraft in flight due to a pressure difference between the pressure face and the suction face of the wings. The wake vortices can remain for several minutes after the passage of a first aircraft and can disrupt the comfort of passengers on a second aircraft passing in the vicinity in the meantime. Safety distances between aircrafts in flight are applied by Air Traffic Control (ATC) in order to take into account wake vortices and to avoid possible flight difficulties associated with their existence. It would seem to be desirable for these ATC procedures to be supplemented by an on-board system in the second aircraft.

In a particular context, in formation, a leader aircraft is followed by one or more follower aircrafts, which can experience discomfort associated with the wake vortices of the leader aircraft. However, by controlling their position relative to the wake vortices, the follower aircrafts can benefit from an upward airflow phenomenon induced by the wake vortices, thereby reducing drag and fuel consumption. However, if the follower aircrafts enter the space between the wake vortices of the leader aircraft, the follower aircrafts experience a downward airflow phenomenon that is induced by the wake vortices and that adversely affects their performance. Similarly, a follower aircraft experiences turbulence if one of its wings enters a wake vortex. This turbulence causes significant discomfort for the passengers of the follower aircraft. Solutions exist to allow a follower aircraft to automatically position itself relative to a wake vortex generated by a leader aircraft. Reference can be made, for example, to the French patent application FR 3041121 A1. Although the solution disclosed therein allows a follower aircraft to effectively benefit from the upward airflow phenomenon induced by a wake vortex of a leader aircraft, the aforementioned discomfort can be experienced by the passengers of the follower aircraft, especially due to sudden disruptive events, such as a maneuver of the leader aircraft, or a change in wind direction or gradient. It is then also desirable to provide a solution for assisting tracking of a wake vortex which is adapted for formation flight, in order to alleviate the aforementioned discomfort for the passengers, while benefiting as much as possible from the upward airflow phenomenon induced by the wake vortex of the leader aircraft.

### SUMMARY OF THE INVENTION

A method is proposed for assisting the formation flight of aircraft, the method being implemented by a system in the form of electronic circuitry on board an aircraft acting as a follower aircraft, the method comprising the following steps: acquiring information relating to a leader aircraft generating a wake vortex inducing an upward airflow, which the system intends the follower aircraft to benefit from; determining an effect of the wake vortex experienced by the follower aircraft as a difference between measurements, taken by sensors of the follower aircraft, and modelling of the follower aircraft in a wake vortex-free environment; determining an estimated position of the wake vortex from the acquired information relating to the leader aircraft and from a wake vortex model, and determining an estimation uncertainty around the estimated position of the wake vortex from the determined effect of the wake vortex experienced by the follower aircraft. The method further comprises a step of determining trajectories comprising: a first trajectory, intended to be followed by the follower aircraft, as a trajectory for approaching and tracking the wake vortex, so as to seek to benefit from the upward flow induced by the wake vortex, while remaining outside a potential discomfort window defined by the estimation uncertainty around the estimated position of the wake vortex; a second trajectory corresponding to a phantom aircraft as if the follower aircraft is permanently in an optimal position relative to the wake vortex, namely a placement of the follower aircraft at a predefined distance from the estimated position of the wake vortex when allowed by the dimensions of the potential discomfort window, and otherwise at a predefined margin from the potential discomfort window. Moreover, the method also comprises the following steps: assessing future overshoots of the phantom aircraft relative to maneuvering capabilities of the follower aircraft and to passenger comfort rules, with respect to the second trajectory; possibly modifying the first trajectory to be followed by the follower aircraft as a function of the assessed overshoots. Thus, by virtue of the second trajectory corresponding to a phantom aircraft, the trajectory to be followed by the follower aircraft can be adjusted in the event of sudden disruptive events, such as a maneuver of the leader aircraft, or a change of wind direction or gradient, which improves the comfort of the passengers of the follower aircraft.

In a particular embodiment, the system assesses the first trajectory to determine whether the follower aircraft approaches the potential discomfort window below a distance threshold TH_vf, and, when this threshold TH_vf is reached, the system makes a tactical decision to move the follower aircraft away from the wake vortex so as to place the follower aircraft at a minimum distance from the wake vortex at which the impact of the wake vortex on the follower aircraft is null.

In a particular embodiment, when the assessed overshoots are smaller in magnitude than a threshold TH_os and are greater in magnitude than a threshold TH_mos, with TH_mos<TH_os, the system makes a tactical decision to shift the target position in order to move the follower aircraft away from the wake vortex by a distance that is equal to a predefined margin.

In a particular embodiment, if the assessed overshoots become greater than or equal in magnitude to the threshold TH_os, the system makes a tactical decision to move the follower aircraft away from the wake vortex so as to place the follower aircraft at a minimum distance from the wake vortex at which the impact of the wake vortex on the follower aircraft is null.

In a particular embodiment, if, despite the tactical decision to move the follower aircraft away from the wake vortex so as to place the follower aircraft at a minimum distance from the wake vortex at which the impact of the wake vortex on the follower aircraft is null, the system detects that the follower aircraft is approaching the potential discomfort window below a distance threshold TH_cr, the system makes a tactical decision to perform an evasive maneuver.

In a particular embodiment, the evasive maneuver involves diving in order to join a lower flight level.

In a particular embodiment, each trajectory is determined by the following steps: time discretization of the trajectory according to a predefined time step, by assessing a total available prediction time corresponding to a time that is supposed to elapse in order for the follower aircraft to substantially cover the distance corresponding to the wake vortex already formed between the leader aircraft and a current position of the follower aircraft to be considered, so as to define iterative microcycles; and, for each iterative microcycle: predicting a future state of the follower aircraft from a current state of the aircraft and modelling of the follower aircraft; predicting the position of the follower aircraft relative to a geodetic reference frame; predicting the positions of the follower aircraft relative to the wake vortex and law feedback.

In a particular embodiment, the estimated position of the wake vortex and the estimation uncertainty concerning the estimated position of the wake vortex are determined using a recursive Bayesian filter.

A system is also proposed for assisting the formation flight of aircraft, the system comprising electronic circuitry intended to be placed on board an aircraft acting as a follower aircraft, the electronic circuitry being configured to implement the following steps: acquiring information relating to a leader aircraft generating a wake vortex inducing an upward airflow, which the system intends the follower aircraft to benefit from; determining an effect of the wake vortex experienced by the follower aircraft as a difference between measurements, taken by sensors of the follower aircraft, and modelling of the follower aircraft in a wake vortex-free environment; determining an estimated position of the wake vortex from the acquired information relating to the leader aircraft and from a wake vortex model, and determining an estimation uncertainty around the estimated position of the wake vortex from the determined effect of the wake vortex experienced by the follower aircraft. The electronic circuitry is further configured to implement a step of determining trajectories comprising: a first trajectory, intended to be followed by the follower aircraft, as a trajectory for approaching and tracking the wake vortex, so as to seek to benefit from the upward flow induced by the wake vortex, while remaining outside a potential discomfort window defined by an estimation uncertainty around the estimated position of the wake vortex; a second trajectory corresponding to a phantom aircraft as if the follower aircraft is permanently in an optimal position relative to the wake vortex, namely a placement of the follower aircraft at a predefined distance from the estimated position of the wake vortex when allowed by the dimensions of the potential discomfort window, and otherwise at a predefined margin from the potential discomfort window. The electronic circuitry is also configured to implement the following steps: assessing future overshoots of the phantom aircraft relative to maneuvering capabilities of the follower aircraft and to passenger comfort rules, with respect to the second trajectory; possibly modifying the first trajectory to be followed by the follower aircraft as a function of the assessed overshoots.

### BRIEF DESCRIPTION OF THE DRAWINGS

The aforementioned features of the invention, as well as others, will become more clearly apparent upon reading the following description of at least one embodiment, with said description being provided with reference to the accompanying drawings, in which:

FIG. 1 schematically illustrates, as a top view, an aircraft equipped with a system for assisting tracking of a wake vortex;

FIG. 2 schematically illustrates an example of hardware architecture on which the system for assisting tracking of a wake vortex can be based;

FIG. 3 schematically illustrates, as a front view, a position of a follower aircraft relative to a leader aircraft during a formation flight;

FIG. 4 schematically illustrates, as a top view, the position of a follower aircraft relative to the leader aircraft during formation flight;

FIG. 5 schematically illustrates a modular architecture of the system for assisting the tracking of a wake vortex, particularly adapted to formation flight;

FIG. 6 schematically illustrates an algorithm for controlling the position of the follower aircraft relative to the leader aircraft during formation flight;

FIG. 7 schematically illustrates an algorithm for determining a probability of the presence of a wake vortex at a given position, in a particular embodiment;

FIG. 8 schematically illustrates an example of a potential discomfort window determined for the follower aircraft, in a particular embodiment; and

FIG. 9 schematically illustrates an algorithm for determining trajectories, in a particular embodiment.

### DETAILED DISCLOSURE OF EMBODIMENTS

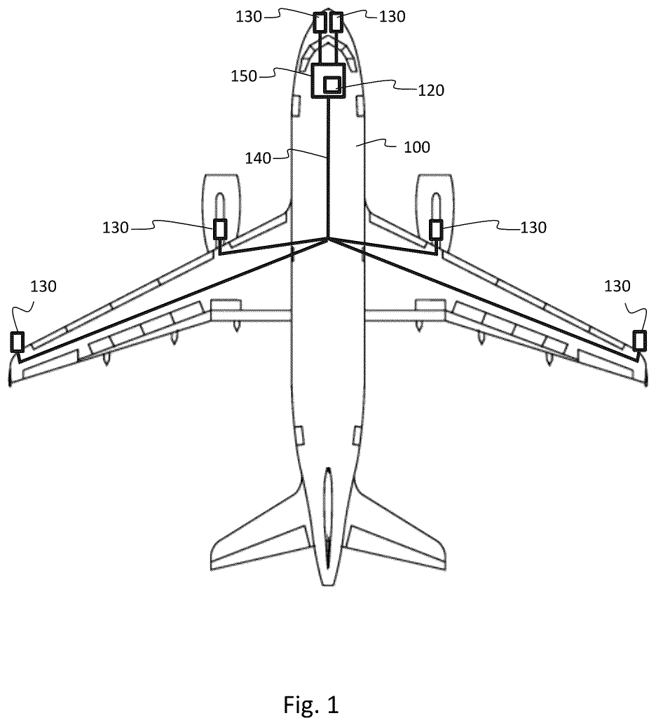

FIG. 1 schematically illustrates, as a top view, an aircraft 100 equipped with a system 120 for assisting tracking of a wake vortex. In a particular embodiment, described below, the system 120 for assisting tracking of a wake vortex is included in a formation flight assistance system, more specifically when the aircraft 100 acts as a follower in the formation flight, in order to benefit from an upward airflow phenomenon induced by a wake vortex of a leader aircraft.

In a particular embodiment, the system 120 is integrated in the avionics 150 of the aircraft 100.

The aircraft 100 is equipped with numerous sensors 130, as is usually the case in aeronautics: temperature sensors, vibration sensors (for example, in the form of accelerometers), pressure sensors, inertial sensors, etc. These sensors 130 provide information, supplemented by information communicated by radio frequency (for example, air-ground or satellite communications), allowing the avionics 150 to determine parameters relating to the aircraft 100 in flight (speed, attitude, altitude, etc.) and to its environment (atmospheric pressure, air speed, etc.). Each sensor 130 is connected to the avionics 150 by electrical wiring, or a communication system (communication bus, communication network, etc.) 140, as shown in a purely illustrative manner in FIG. 1.

The system 120 relies on information provided by the avionics 150, in particular by virtue of the sensors 130, as well as on information provided by the leader aircraft and on pre-established models, in order to assist the aircraft 100 in avoiding discomfort for the passengers of the aircraft 100 due to turbulence generated by a wake vortex generated by another aircraft. In a particular embodiment, as disclosed below, the system 120 relies on information provided by the avionics 150, in particular by virtue of the sensors 130, as well as on information provided by the leader aircraft and on pre-established models, in order to assist in positioning the aircraft 100, acting as a follower aircraft in a formation flight, so as to benefit from the aforementioned upward airflow phenomenon, without causing discomfort for the passengers of the aircraft 100.

In a particular embodiment, the system 120 is disengageable and is activated during phases of formation flight when the aircraft 100 is a follower. For example, the system 120 is activated/deactivated on the command of a pilot of the aircraft 100.

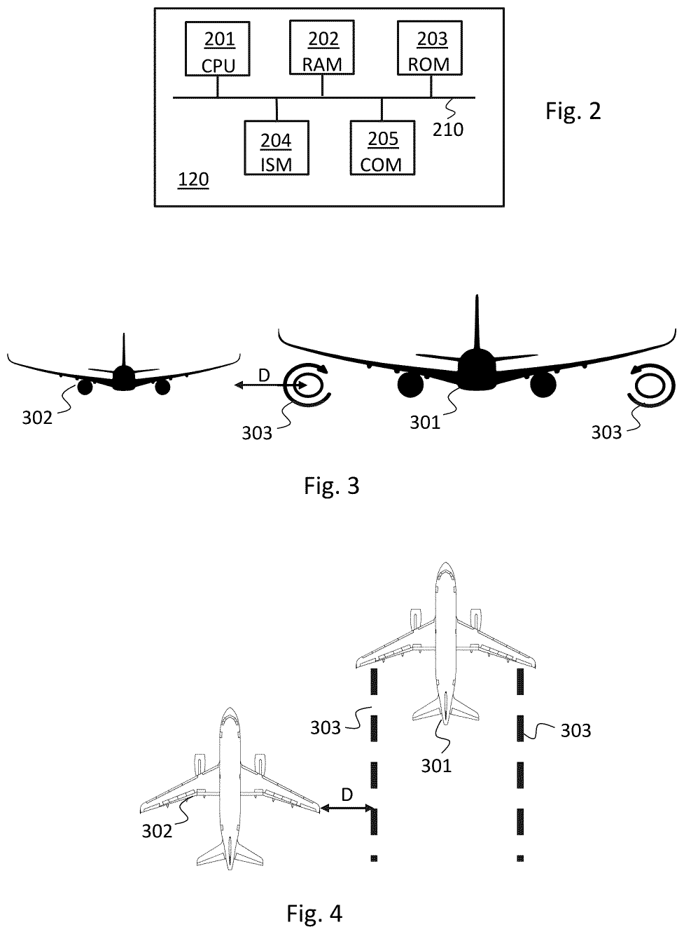

FIG. 2 schematically illustrates an example of hardware architecture on which the system 120 can be based.

The system 120 then comprises, connected by a communication bus 210: a processor or CPU (“Central Processing Unit”) 201; a RAM (“Random Access Memory”) 202; a ROM (“Read Only Memory”) 203, for example, a Flash memory; a data storage device, such as an HDD (“Hard Disk Drive”), or an ISM (“Information Storage Medium”) 204, such as an SD (“Secure Digital”) card reader; at least one communication interface 205 allowing the system 120 to more specifically interact with the avionics 150, as well as with the avionics of the leader aircraft or with ground-based equipment acting as a relay with the avionics of the leader aircraft.

The processor 201 is capable of executing instructions loaded into the RAM 202 from the ROM 203, an external memory (not shown), a storage medium, such as an SD card, or a communications network (not shown). When the system 120 is powered on, the processor 201 is able to read instructions from the RAM 202 and to execute them. These instructions form a computer program causing the processor 201 to implement the modular architecture, behaviors, steps and algorithms described herein.

All or part of the modular architecture, behaviors, steps and algorithms described herein thus can be implemented in software form by executing a set of instructions using a programmable machine, such as a DSP (Digital Signal Processor) or a microprocessor, or can be implemented in hardware form using a dedicated machine or chip or chipset, such as a Field-Programmable Gate Array (FPGA) or Application-Specific Integrated Circuit (ASIC). The system 120 therefore comprises electronic circuitry arranged and configured to implement the modular architecture and the behaviors, steps and algorithms described herein.

FIG. 3 schematically illustrates, as a front view, a position of a follower aircraft 302 relative to a leader aircraft 301 during a formation flight. The aircraft 301 and 302 are in cruise flight. The movement of the leader aircraft 301 generates wake vortices 303. If the follower aircraft 302 maintains a distance D ranging between a minimum threshold distance Dmin (for example, Dmin=20 meters) and a maximum threshold distance Dmax (for example, Dmax=30 meters) from the marginal vortices outside the trajectory of the leader aircraft 301, the follower aircraft 302 benefits from the aforementioned upward airflow phenomenon, thereby reducing drag and fuel consumption for the follower aircraft 302. Between the minimum threshold distance Dmin and the maximum threshold distance Dmax, placing the follower aircraft 302 at a distance Dconf (for example, Dconf=25 meters, plus or minus a predefined margin) allows significant benefit to be drawn from the upward airflow phenomenon, while ensuring the comfort of the passengers of the follower aircraft 302.

In addition to FIG. 3, FIG. 4 schematically illustrates the position of the follower aircraft 302 relative to the leader aircraft 301 as a top view.

The wake vortices 303 are schematically shown in a simplified manner. Indeed, from the wings, the wake vortices 303 firstly tend to approach each other, then to maintain a substantially constant distance between them, while losing altitude relative to the altitude at which they were generated. In addition, any maneuvers of the leader aircraft 301, as well as the wind, influence the trajectory and the geometry of the wake vortices 303 over time.

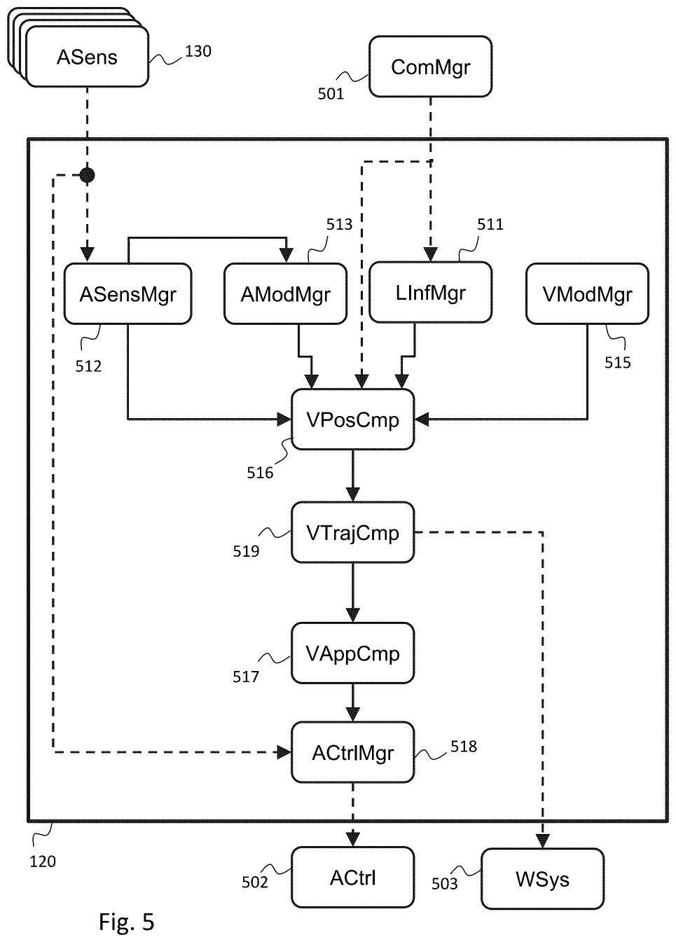

FIG. 5 schematically illustrates a modular architecture of the system 120 adapted for wake vortex tracking, and particularly adapted for formation flight.

The system 120 comprises a sensor management module ASensMgr 512 that is configured to gather information in real-time that relates to the measurements taken by the sensors 130 (denoted ASens in FIG. 5), including information concerning current atmospheric conditions (for example, wind speed and direction), as well as information concerning any effects experienced by the follower aircraft 302 (for example, roll acceleration).

The system 120 also comprises a module LInfMgr 511 for managing information relating to the leader aircraft 301 (wingspan, mass, geographical position, speed, altitude, attitude, wind variations experienced, dynamics (for example, roll, etc.). Said information includes information concerning the wind experienced by the leader aircraft 301 (force, direction, etc.). The module LInfMgr 511 receives this information, and any updates thereof, in real-time, from a communications management system ComMgr 501 of the avionics 150 communicating with an on-board system of the leader aircraft 301, possibly via an intermediate relay (for example, ground-based communication system or satellite system).

The system 120 further comprises an aircraft model management module AModMgr 513 configured to determine the effects of the wake vortex 303 on the follower aircraft 302. The aircraft model management module AModMgr 513 uses measurements provided by the sensors ASens 130 (for example, roll acceleration) in order to determine the effects experienced by the follower aircraft 302. The module AModMgr 513 also uses a model of the follower aircraft 302 modelling the effects experienced by the follower aircraft 302 in flight outside the wake of another aircraft (for example, aerodynamic properties as a function of the mass of the aircraft). For example, for a certain aileron deflection, a certain roll acceleration is expected in an environment without a wake vortex generated by another aircraft. Thus, the module AModMgr 513 is configured to determine the effects of the wake vortex 303 on the follower aircraft 302 by subtracting the effects contained in said model of the follower aircraft 302 from the effects measured by the sensors ASens 130.

The system 120 further comprises a wake vortex position computation module VPosCmp 516. The module VPosCmp 516 is configured to estimate a position of the wake vortex 303 with an estimation uncertainty, which itself can be determined, and is configured to determine a spatial window, called potential discomfort window, defined by the estimation uncertainty around the estimated position of the wake vortex 303. In a particular embodiment, the potential discomfort window defines a space in which the wake vortex 303 is assumed to be present with a probability that is greater than or equal to a predetermined threshold TH_vx.

In addition to this potential discomfort window that represents discomfort experienced by passengers due to turbulence induced by the wake vortex 303, passenger comfort (or discomfort) is defined as a function of a set of rules relating to the maneuvers of the follower aircraft 302, in particular the load factor.

To this end, the module VPosCmp 516 computes a geo-referenced geometry of the wake vortex 303.

The module VPosCmp 516 is also configured to compute the geo-referenced geometry of the wake vortex 303, which induces the upward airflow phenomenon that the follower aircraft 302 can benefit from, from information relating to the leader aircraft 301 (such as the wingspan, the mass, the geographical position, the speed, the altitude, the attitude, etc.) and from information relating to the atmospheric conditions (for example, wind speed and direction) encountered by the leader aircraft 301 and the follower aircraft 302. The computation of the geo-referenced geometry of the wake vortex 303 is well known to a person skilled in the art and involves several steps: constructing successive geo-referenced positions through which the leader aircraft 301 has passed, computing wind-related drift, and taking into account the physics of the wake vortex, in particular with a descent speed. The module VPosCmp 516 thus produces, in real-time, a three-dimensional geo-referenced model of the geometry of the wake vortex 303. Then, by projecting the position of the follower aircraft 302 onto computed positions of the center of the wake vortex, a distance can be computed from the follower aircraft 302 to the wake vortex. Implementation and computation details are disclosed, for example, in the aforementioned French patent application FR 3041121 A1.

In order to determine the geo-referenced geometry of the wake vortex 303, the module VPosCmp 516 uses data (descent speed, etc.) provided by a wake vortex model. The system 120 then comprises a wake vortex model management module VModMgr 515 providing the module VPosCmp 516 with said wake vortex model data.

The module VPosCmp 516 is thus configured to determine, for example, using a recursive Bayesian filter, an estimated position of the wake vortex from the acquired information relating to the leader aircraft and from a wake vortex model, and to determine an estimation uncertainty on the estimated position of the wake vortex by comparing the effect of the wake vortex 303 experienced by the follower aircraft 302 and a theoretical effect of the wake vortex 303 on the follower aircraft 302 according to the wake vortex model. Indeed, particularly due to measurement inaccuracies and/or inaccuracies of the models used, uncertainty exists concerning the effective geometry and geo-referencing of the wake vortex 303 computed and geo-referenced by the module VPosCmp 516 by virtue of the recursive Bayesian type filter.

The module VPosCmp 516 is thus configured to determine the potential discomfort window associated with the estimated position of the wake vortex as a function of the estimation uncertainty on the estimated position of the wake vortex. In one embodiment, the module VPosCmp 516 determines the potential discomfort window by applying a distance dependent on the estimation uncertainty (for example, proportional to the estimation uncertainty or linearly dependent on the estimation uncertainty), around the estimated position of the wake vortex 303. Thus, the greater the estimation uncertainty, the greater the dimensions of the potential discomfort window. The accuracy of the estimation then can be improved by enhancing observability, in order to allow the dimensions of the potential discomfort window to be reduced.

In another embodiment, by virtue of a particle filter, the module VPosCmp 516 determines the theoretical effect of the wake vortex 303 on the follower aircraft 302 at different potential positions of said wake vortex 303 in view of the previously computed geo-referenced geometry, and compares, for each position from among said different potential positions, this theoretical effect with the effect of said wake vortex 303 on the aircraft 302 as determined by the module AModMgr 513 (for example, using pitch moment data). The module VPosCmp 516 then determines a value of the probability of the presence of the wake vortex 303 in said position. Thus, if the theoretical effect is too small compared to the effect actually experienced by the follower aircraft 302 based on the measurements of the sensors ASens 130, i.e., the probability value is below the predetermined threshold TH_vx, it is unlikely that the wake vortex 303 is located in this position. The spatial window in which the wake vortex 303 is assumed to be present with a probability greater than or equal to the predetermined threshold TH_vx is a space of potential discomfort for the passengers of the follower aircraft 302, due to turbulence that is potentially experienced by the follower aircraft 302 and is caused by said wake vortex 303. This spatial window then constitutes the aforementioned potential discomfort window.

In a particular embodiment, the module VPosCmp 516 determines a value of the probability of the presence of the wake vortex 303 in each of said positions for different features of the wake vortex (vortex diameter, velocity profiles, circulation profiles, etc.).

As an alternative embodiment to the particle filter described above, the module VPosCmp 516 can include another type of recursive Bayesian filter, such as a Kalman filter.

Other approaches for estimating the position of the wake vortex 303 and the associated estimation uncertainty, such as a computation of local gradients, can be derived from the general knowledge of a person skilled in the art. The position of the wake vortex 303 also can be acquired from direct measurements of the wake vortex 303 (for example, using Light Detection And Ranging (LIDAR) technology) and a geometric propagation model.

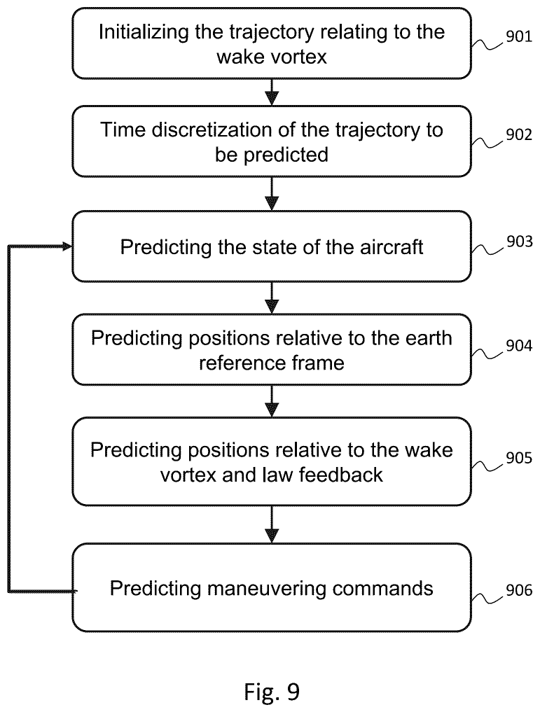

The module VPosCmp 516 performs distance computations relative to the wake vortex 303 in a two-dimensional space, in a [Y, Z] plane in an [X, Y, Z] geodetic reference frame, as shown in FIG. 9. The three-dimensional space [X, Y, Z] in which the geo-referenced geometry of the wake vortex 303 is computed allows tracking of the trajectory, and the cross-section in the [Y, Z] plane is used to determine the potential discomfort window, i.e., the estimated position of the wake vortex 303 taking into account computation uncertainties.

In a particular embodiment, the module VPosCmp 516 is made up of two sub-modules, for computational capacity purposes: a first sub-module with a rough estimator of the position of the wake vortex 303 (with a first accuracy level) and a second sub-module with a refinement estimator (with a second accuracy level better than the first accuracy level). The first sub-module can then perform a geometric computation that is relatively rough and does not take into account all the wind and wake vortex dynamics. The second sub-module then uses a more accurate model, which initializes on the results of the first sub-module and which corrects any computation uncertainties of the first sub-module by means of a more precise estimator (recursive Bayesian filter, etc.).

The system 120 further comprises a prediction module VTrajCmp 519. The module VTrajCmp 519 is configured to perform various trajectory computations for the follower aircraft 302.

Indeed, in order to be able to benefit from the upward airflow generated by the wake vortex 303, the system 120 is configured to seek to enter a tracking phase, in which the system 120 defines the successive positions of the trajectory of the follower aircraft 302 in accordance with the following conditions: when the dimensions of the potential discomfort window are so large that the follower aircraft 302 cannot be placed at the distance Dconf, the system 120 defines the trajectory of the follower aircraft 302 in order to remain at a distance equal to a predefined margin from the potential discomfort window; and, when the dimensions of the potential discomfort window are small enough for the follower aircraft 302 to be placed at the distance Dconf, the system 120 keeps the follower aircraft 302 at the distance Dconf. Thus, the follower aircraft 302 benefits from the upward airflow generated by the wake vortex 303, while avoiding discomfort for the passengers of the follower aircraft 302.

When the follower aircraft 302 is not in a tracking phase, the system 120 voluntarily keeps the follower aircraft 302 away from the wake vortex 303, or is in a transient regime, in which the system 120 applies a trajectory for approaching the wake vortex 303. However, the system 120 is configured to anticipate situations that instead require moving away from the wake vortex 303 in order to avoid turbulence associated with the wake vortex 303 that would be uncomfortable for the passengers of the follower aircraft 302, and to then either forgo this trajectory for approaching the wake vortex 303 or to move further away from the wake vortex 303. Indeed, it is desirable to anticipate situations where, for example, due to a change in wind direction or strength, or a maneuver of the leader aircraft 301, the follower aircraft 302 no longer can be kept at the distance DConf from the trajectory of the wake vortex 303 without generating discomfort for its passengers. Thus, depending on the detected situation, the system 120 can forgo the approach trajectory and assume some lateral margin with respect to the wake vortex 303, or move the follower aircraft 302 away, beyond the aforementioned threshold distance Dmax, or perform an evasive maneuver such as diving, for example. To this end, the module VTrajCmp 519 is preferably configured to compute candidate trajectories adapted for these maneuvers.

The module VTrajCmp 519 computes at least two trajectories:
a first trajectory that corresponds to the trajectory intended to be followed by the follower aircraft 302, with the first trajectory being made up of target positions to be reached by the follower aircraft 302 relative to the future positions of the wake vortex 303 and this occurs in a predefined time interval in the immediate future (total available prediction time; for example, the next 10 seconds). This first trajectory is therefore initialized with the current position of the follower aircraft 302 and the current target position of the follower aircraft 302. When the system 120 does not detect a situation or event involving the application of a tactic for moving away from the wake vortex 303, as described below, the first trajectory is computed as a trajectory for approaching and tracking the wake vortex 303;
a second trajectory that corresponds to the trajectory of the follower aircraft 302 as if the follower aircraft 302 is permanently in an optimal position (i.e., at the distance Dconf) with respect to the wake vortex 303. This trajectory therefore corresponds to a phantom (or virtual) aircraft, and is initialized with an optimal position (i.e., at the distance Dconf) with respect to the wake vortex 303 and a target position keeping the follower aircraft 302 at the distance Dconf relative to the wake vortex 303.

In the computation of the first trajectory, the module VTrajCmp 519 seeks to keep the follower aircraft 302 outside the potential discomfort window while seeking to benefit from the upward airflow induced by the wake vortex 303. Typically, the module VTrajCmp 519 computes successive target positions forming the first trajectory with the following constraints:
to not enter the potential discomfort window (the dimensions of which can evolve as a function of new measurements gathered in real-time), while seeking to benefit from the upward airflow induced by the wake vortex;
to gather new measurements to allow the distribution of probabilities to be corrected and thus improve the estimation performance capabilities and reduce the size of the potential discomfort window; and
to define trajectories that are comfortable, or even imperceptible, for the passengers of the follower aircraft 302.

The second trajectory allows the transient regime to be separated from the steady state regime. For example, when the follower aircraft 302 makes an approach to the wake vortex 303, the follower aircraft 302 is then in motion in order to approach the wake vortex 303 (while remaining outside the potential discomfort window). In this case, it is not possible to determine, with respect to the actual trajectory of the follower aircraft 302, that the atmospheric conditions and the movements of the wake vortex 303 (for example, due to a maneuver by the leader aircraft 301) are too great to be absorbed by the control laws of the follower aircraft 302 without discomfort for the passengers of the follower aircraft 302. The second trajectory therefore allows the viability to be assessed of keeping the wake vortex 303 at an optimal distance (Dconf), in terms of passenger comfort, without physically having to be at an optimal distance (Dconf) from the wake vortex 303.

The system 120 further comprises a trajectory management module VAppCmp 517 for defining the trajectory actually to be followed by the follower aircraft 302. The module VAppCmp 517 manages the trajectory of the follower aircraft 302 so that the follower aircraft 302 remains outside the potential discomfort window, while seeking to benefit from the upward flow induced by the wake vortex 303, and anticipates situations in which the follower aircraft 302 risks entering said potential discomfort window.

Thus, the module VAppCmp 517 is configured to make tactical decisions for controlling the follower aircraft 302, including: maintaining the first trajectory, to be followed by the follower aircraft 302, as the trajectory for approaching said wake vortex 303 and tracking the wake vortex 303, or, in the event of a situation requiring making a tactical decision to move away, modifying the first trajectory in order to give more lateral margin to the actual trajectory of the follower aircraft 302 relative to that of the wake vortex 303, or to perform an evasive maneuver.

More specifically, the first and second trajectories are used by the module VAppCmp 517 as follows.

The module VAppCmp 517 monitors the first trajectory in order to assess whether the follower aircraft 302 is approaching, in terms of approaching and tracking the wake vortex 303, the potential discomfort window below a distance threshold TH_vf. When this threshold TH_vf is reached, the module VAppCmp 517 decides to move the follower aircraft 302 away from the wake vortex 303 so as to place the follower aircraft 302 at a minimum distance from the wake vortex 303 at which the impact of the wake vortex 303 on the follower aircraft 302 is null (i.e., beyond the aforementioned threshold distance Dmax). For example, to this end the module VAppCmp 517 selects a candidate trajectory to be applied to the first trajectory. This is referred to as “vortex free” flight. In this way, passing below the threshold TH_vf is avoided in order to limit the risk of entering the potential discomfort window and generating passenger discomfort.

As already stated, the second trajectory corresponds to a virtual aircraft, or phantom aircraft, as if the follower aircraft 302 were at the optimal distance Dconf from the wake vortex 303. Using the second trajectory, the module VAppCmp 517 assesses future overshoots of the phantom aircraft relative to the target position as a function of the maneuvering capabilities of the follower aircraft 302 and the comfort rules of its passengers, such as, but not limited to, horizontal (Y), vertical (Z), roll (phi), and vertical speed (Vz) overshoots of this virtual aircraft with respect to the target position. When the assessed overshoots are smaller in magnitude than a threshold TH_os (for example, 20 meters), the module VAppCmp 517 makes a tactical decision to take a margin on the actual target position of the follower aircraft 302, i.e., by shifting the target position away from the wake vortex 303 by a distance that is equal to this margin (for example, 10 meters for overshoots of 20 meters). In a particular embodiment, the module VAppCmp 517 makes a tactical decision to take such a position margin only if the assessed overshoots are greater in magnitude than a threshold TH_mos (with TH_mos<TH_os). If the assessed overshoots become greater than or equal in magnitude to the threshold TH_os, the module VAppCmp 517 makes a tactical decision to move the follower aircraft 302 away from the wake vortex 303 so as to place the follower aircraft 302 at a minimum distance from the wake vortex 303 at which the impact of the wake vortex 303 on the follower aircraft 302 is null (namely, beyond the aforementioned threshold distance Dmax), i.e., in “vortex free” flight.

If, despite the tactical decision to move the follower aircraft 302 away from the wake vortex 303 so as to place the follower aircraft 302 at a minimum distance from the wake vortex 303 at which the impact of the wake vortex 303 on the follower aircraft 302 is null, the module VAppCmp 517 detects that the follower aircraft 302 is still approaching the potential discomfort window below a distance threshold TH_cr (with TH_cr being less than TH_vf), the module VAppCmp 517 makes a tactical decision to perform an evasive maneuver. The evasive maneuver preferably involves diving in order to join a lower flight level. In this way, passing below the threshold TH_cr, which could generate even greater passenger discomfort, is avoided.

The module VTrajCmp 519 could be configured to compute other candidate trajectories. These other candidate trajectories allow the module VAppCmp 517 to assess the possibility of the follower aircraft 302 moving away from the wake vortex 303 at predefined distances below the threshold distance Dmax (i.e., without going as far as a return to “vortex free” flight). The module VAppCmp 517 is then configured to select an optimized trajectory from among all these candidate trajectories.

In a particular embodiment, the module VAppCmp 517 is configured, when it detects that the dimensions of the potential discomfort window allow the follower aircraft 302 to be placed at the distance Dconf relative to the estimated position of the wake vortex (while therefore remaining outside the potential discomfort window), to command the follower aircraft 302 to perform movements with a load factor below a predetermined threshold TH_lf. Thus, the system 120 enhances observability of the wake vortex 303 in a manner that is comfortable, even imperceptible, for the passengers of the follower aircraft 302.

The system 120 further comprises an aircraft command control management module ACtrlMgr 518 configured to convert each trajectory determined by the module VAppCmp 517 into maneuvering commands for the follower aircraft 302. The maneuvering commands are then transmitted to a flight command management system ACtrl 502 (servo controls) of the avionics 150, for example, integrated in an autopilot system.

In a particular embodiment, the system 120 comprises a warning module WSys 503. Indeed, the module VTrajCmp 519 can be used outside formation flight. The system 120 then receives information concerning any other aircraft within a predefined radius. Thus, the module WSys 503 uses the trajectories provided by the module VTrajCmp 519 to avoid unintentionally encountering a wake vortex of another aircraft (outside formation flight).

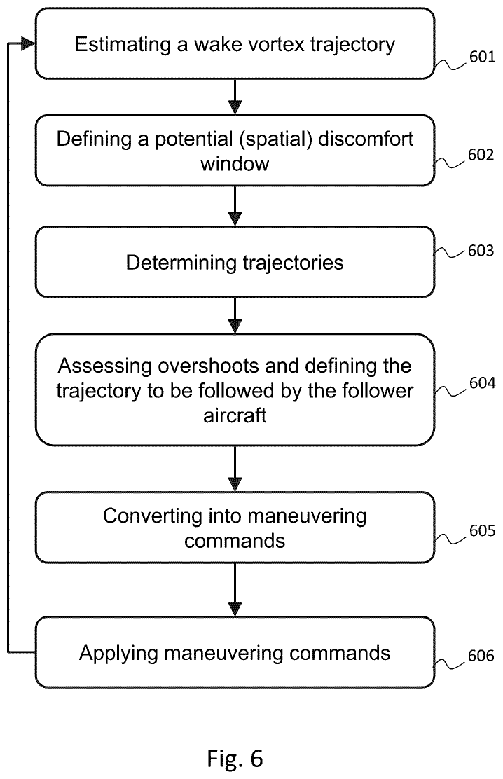

FIG. 6 schematically illustrates an algorithm for controlling the position of the follower aircraft 302 relative to the leader aircraft 301 during formation flight.

In a step 601, the system 120 estimates the geometry of the wake vortex 303, the upward flow phenomenon of which the follower aircraft 302 seeks to benefit from, as already described in relation to the module VPosCmp 516.

In a step 602, the system 120 determines a potential discomfort window for the passengers of the follower aircraft 302, as is also already described in relation to the module VPosCmp 516.

In a step 603, the system 120 determines the aforementioned first trajectory, the aforementioned second trajectory, and possibly candidate trajectories, as already described in relation to the module VTrajCmp 519. These trajectories are used by the system 120, and in particular by the module VAppCmp 517 as described above, to determine target positions defining a trajectory to be followed by the follower aircraft 302 while avoiding entering the potential discomfort window, with the target positions taking into account the future movements of the wake vortex 303 and the maneuvering capabilities (gains, control laws, saturation) of the follower aircraft 302 for limiting the discomfort of its passengers.

In a step 604, the system 120 defines the trajectory to be followed by the follower aircraft 302, from the trajectories determined in step 603. As already explained above in relation to the modules VTrajCmp 519 and VAppCmp 517, the assessments of overshoots with respect to the second trajectory possibly cause the system 120 to modify the first trajectory followed by the follower aircraft 302, for example, by selecting a candidate trajectory for modifying the first trajectory. The defined trajectory is converted into aircraft maneuvering commands in a subsequent step 605. This trajectory is intended to avoid entering the potential discomfort window, by anticipating variations in the trajectory of the wake vortex 303 (wind, maneuver of the leader aircraft 301).

As the flight proceeds, the system 120 continues to acquire measurements taken by the sensors 130. By virtue of these measurements, the system 120 updates the potential discomfort window and accordingly adjusts the candidate trajectories and therefore the trajectory to be followed.

Gathering new measurements in real-time that are taken by the sensors 130 when executing the approach trajectory towards the wake vortex 303, and in the tracking phase, allows the position and the dimensions of the potential discomfort window to be updated in real-time. The module VAppCmp 516 uses the potential discomfort window to allow data to be gathered as close as possible to the wake vortex 303, where said data is most relevant for reducing estimation uncertainty, without the passengers of the follower aircraft 302 experiencing any discomfort.

In a particular embodiment, the system 120 commands the follower aircraft 302 to perform low load factor movements, i.e., with a load factor below the predetermined threshold TH_lf, which is a threshold above which the movements of the aircraft are considered to be uncomfortable, or noticeable, for the passengers. The movements in question are in the [Y, Z] plane (vertical and/or lateral movements). The movements in question are preferably vertical oscillatory or pseudo-oscillatory movements. These movements allow the follower aircraft 302 to be relatively moved relative to the wake vortex 303 and allow new measurements to be acquired from the sensors 130 (enhancing “observability”), in order to refine the definition of the potential discomfort window.

In step 605, the system 120 converts the trajectory defined in step 604 into aircraft maneuvering commands so as to cause the follower aircraft 302 to follow the defined trajectory.

In a step 606, the system 120 applies the maneuvering commands acquired in step 605 to the follower aircraft 302. The algorithm then loops back to step 601, so as to take into account the changes in the position and the geometry of the wake vortex 303, any changes in the atmospheric conditions, and to change the potential discomfort window accordingly.

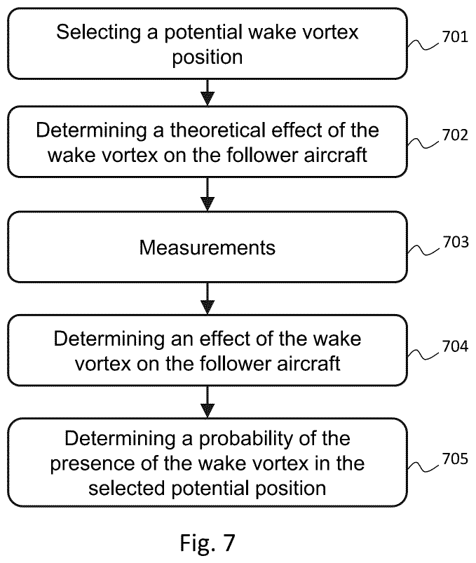

FIG. 7 schematically illustrates an algorithm for determining a probability of the presence of a wake vortex at a given position, thus allowing the potential discomfort window to be determined for the follower aircraft 302, in a particular embodiment adapted to the use of a particle filter. To this end, the algorithm computes a distribution of probabilities of the spatial location of the wake vortex 303. In order to compute this distribution of probabilities, the algorithm computes likelihoods, for example.

In a step 701, the system 120 selects a potential position of the wake vortex 303 from among a set of potential positions. The set of potential positions is defined by an uncertainty analysis, in view of the estimation accuracy (for example, the accuracy of the particle filter), or empirically during in-flight test phases by comparing modelled data and measurement data.

In a particular embodiment, the system 120 integrates a particle filter and each particle represents a potential position of the wake vortex 303 (or its center) in the [Y, Z] reference frame.

In a step 702, the system 120 determines a theoretical effect of the wake vortex 303 on the follower aircraft 302, by considering that the wake vortex 303 is located in the position selected in step 701. To this end, the system 120 uses the aforementioned wake vortex model (provided by the module VModMgr 515).

In a step 703, the system 120 gathers measurements taken by the sensors 130, and in a step 704, determines an actual effect of the wake vortex 303 on the aircraft 302 by virtue of the measurements of the sensors 130 (determined by the module AModMgr 513). In the measurements of the sensors 130, the effect of the wake vortex 303 is predominant compared to other disturbances that would be detected by the sensors 130. Therefore, the effect of these other disturbances on these measurements is negligible.

In a step 705, the system 120 compares the theoretical effect of the wake vortex 303 on the follower aircraft 302 as determined in step 702 with the effect of the wake vortex 303 on the follower aircraft 302 as determined in step 704. The difference between the theoretical effect of the wake vortex 303 on the follower aircraft 302 as determined in step 702 and the effect of the wake vortex 303 experienced by the follower aircraft 302 as determined in step 704 provides a value of the probability of the presence of the wake vortex 303 in the position selected in step 701.

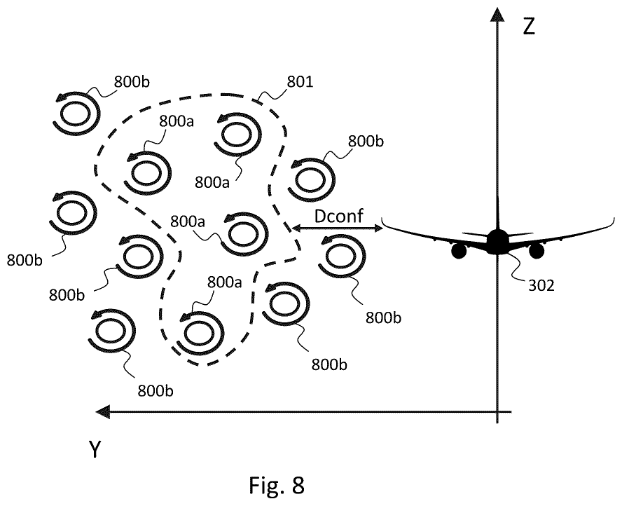

The system 120 proceeds thus for each potential position of said set of potential positions. A probability value (of the presence of the wake vortex) is thus associated with each potential position of said set of potential positions. As already stated, the probability value can be computed for different values of wake vortex parameters (diameter, etc.). The system 120 then divides the potential positions into two categories: those for which the associated probability is greater than or equal to the predetermined threshold TH_vx, and those for which the associated probability is less than the predetermined threshold TH_vx. A grouping of potential positions for which the associated probability is greater than or equal to the predetermined threshold TH_vx forms the aforementioned potential discomfort window. The situation is schematically illustrated in FIG. 8, where potential wake vortex positions 800a have an associated probability that is greater than or equal to the predetermined threshold TH_vx, and are therefore included in the potential discomfort window 801, and where potential wake vortex positions 800b have an associated probability that is less than the predetermined threshold TH_vx, and are therefore excluded from the potential discomfort window 801.

FIG. 9 schematically illustrates an algorithm for determining trajectories for the follower aircraft 302, in a particular embodiment. The algorithm is implemented by the system 120, and more specifically by the module VTrajCmp 519, for each trajectory to be determined. The algorithm takes a geo-referenced geometry of the wake vortex 303 as input, as computed by the module VPosCmp 516. Therefore, the algorithm is implemented at least twice in order to determine (1) the first aforementioned trajectory, and (2) the second aforementioned trajectory.

In particular, the algorithm takes a current position of the follower aircraft 302 to be considered as input (actual position for the first trajectory, virtual position for the second trajectory). The algorithm uses a model of the follower aircraft 302, such as, for example, the one used by the module AModMgr 513, in order to know the maneuvering capabilities of the follower aircraft 302 in situ and the feedback of applicable laws (knowledge of the control laws of the follower aircraft 302 according to the various flight points).

In a step 901, the system 120 initializes the trajectory relative to the wake vortex 303, for example, with the following aircraft parameters: Mach number, ground speed, actual roll (phi), commanded roll, actual load factor (Nz), commanded load factor, latitude, longitude, azimuth, etc. Depending on the modelling that is used, the trajectory also can be initialized with parameters relating to control surface deflections, engine speed, etc. In other words, the trajectory is initialized with any aircraft parameter useful for the modelling that is used. The trajectory is also initialized with the target position (in X, Y, Z).

In a step 902, the system 120 performs a time discretization of the trajectory to be determined. A predefined fixed or variable time step is used. The system 120 assesses a total available prediction time, i.e., the time that is supposed to elapse in order for the follower aircraft 302 to substantially cover the distance covering the wake vortex 303 already formed between the leader aircraft 301 and the position of the follower aircraft 302 to be considered. This total available prediction time depends on the speed of the follower aircraft 302, and on the distance between the follower aircraft 302 and the leader aircraft 301. For example, for a fixed time step dt=0.04 seconds, if the follower aircraft 302 is located 10 seconds behind the leader aircraft 301, and if, in addition, the follower aircraft 302 and the leader aircraft 301 are flying at the same speed, the system 120 performs, during the total available prediction time, which can be called “computing cycle”, 10/0.04=250 iterative microcycles in order to determine the trajectory.

For each iterative microcycle of the time discretization of the trajectory to be determined, the system 120 performs steps 903 to 906 described below. Once steps 903 to 906 have been performed for this “current” iterative microcycle, the system transitions to the next iterative microcycle. In this way, the trajectory is constructed point-by-point, as the iterative microcycles progress.

In step 903, the system 120 predicts the future state of the follower aircraft 302, for the “current” iterative microcycle, based on the current state of the follower aircraft 302 (including the commands applied to the follower aircraft 302) and the aforementioned modelling. A simplified model on each axis during the total available prediction time can be used to this end.

In step 904, the system 120 predicts, for the “current” iterative microcycle d, the position of the follower aircraft 302 relative to the geodetic reference frame [X, Y, Z]. The system 120 computes, for each iterative microcycle of the time discretization of the trajectory to be determined, the predicted latitudes, longitudes and altitudes of the follower aircraft 302 based on the ground speeds, the vertical speed (Vz) and the azimuth of the follower aircraft 302.

In step 905, the system 120 predicts positions relative to the wake vortex 303 and law feedback. The system 120 knows the current positions of the wake vortex 303 by virtue of step 601. Therefore, the system 120 can predict the future positions of the wake vortex 303 as it continues to move under the effect of the wind and its own dynamics. The system 120 also knows the future positions of the follower airplane by virtue of step 904. Therefore, the system 120 can deduce the future relative positions of the follower airplane 302 with respect to the wake vortex 303. Therefore, future avionics feedback from the follower aircraft 302 also can be deduced. This future avionics feedback is used in step 604 to compute the law commands for tracking the target position with the gains from the law and saturations of the flight point.

In step 906, the system 120 predicts the aircraft commands to be applied in order to track the positions determined in step 904. The avionics feedback predicted in step 905 is used to compute the airplane commands. Assuming the simplified models used by the system 120, a roll command (phi) and a load factor command (Nz) are determined using the gains from the law and saturations of the considered flight point. In other words, the system 120 uses a known and acceptable flight envelope that allows the manner the follower aircraft 302 will react to disturbances to be assessed. The flight envelope is understood herein not only in terms of aerodynamics (breaking point of the airplane, stall threshold), but also by taking into account passenger comfort (no excessive roll, limited load factor, etc.).

The algorithm then loops back to step 903 in order to take into account a new iterative cycle.

Thus, by virtue of the knowledge of the future positions of the wake vortex 303 and the future positions of the follower aircraft 302 or the phantom aircraft, the first trajectory or the second trajectory is predicted over a certain time (or distance). For the second trajectory, the assessment of overshoots as a function of the maneuvering capabilities of the follower aircraft 302 relative to the passenger comfort rules provides a measure of the quality of the trajectory tracking. Thus, if the first future trajectory enters the discomfort window, maintaining it will become uncomfortable for the passengers of the follower aircraft 302; and, if the quality of holding trajectory is poor with respect to the second trajectory (significant overshoots), the risk of the follower aircraft 302 entering the potential discomfort window is high in the short term, even if it is not immediately predicted.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting a formation flight of aircraft, the method being implemented by a system comprising electronic circuitry on board an aircraft acting as a follower aircraft, the method comprising the following steps:
acquiring information relating to a leader aircraft generating a wake vortex inducing an upward airflow;
determining an effect of the wake vortex experienced by the follower aircraft as a difference between measurements, taken by sensors of the follower aircraft, and modelling of the follower aircraft in a wake vortex-free environment;
determining an estimated position of the wake vortex from the acquired information relating to the leader aircraft and from a wake vortex model, and determining an estimation uncertainty around the estimated position of the wake vortex from the determined effect of the wake vortex experienced by the follower aircraft;
determining trajectories comprising:
a first trajectory, to be followed by the follower aircraft, as a trajectory for approaching and tracking the wake vortex, so as to benefit from the upward airflow induced by the wake vortex, while remaining outside a potential discomfort window defined by the estimation uncertainty around the estimated position of the wake vortex, and,
a second trajectory corresponding to a phantom aircraft representing the follower aircraft permanently in an optimal position relative to the wake vortex, the optimal position comprising a placement of the follower aircraft at a predefined distance from the estimated position of the wake vortex when allowed by dimensions of the potential discomfort window, and otherwise at a predefined margin from the potential discomfort window;
assessing, with respect to the second trajectory, future overshoots of the phantom aircraft relative to maneuvering capabilities of the follower aircraft and to passenger comfort rules, with respect to the second trajectory; and
modifying the first trajectory to be followed by the follower aircraft as a function of the future overshoots.

2. The method according to claim 1, wherein the system is configured to assess the first trajectory to determine whether the follower aircraft approaches the potential discomfort window below a distance threshold TH_vf, and, when this threshold TH_vf is reached, the system is configured to makes a tactical decision to move the follower aircraft away from the wake vortex so as to place the follower aircraft at a minimum distance from the wake vortex at which an impact of the wake vortex on the follower aircraft is null.

3. The method according to claim 1, wherein, when the assessed future overshoots are smaller in magnitude than a threshold TH_os and are greater in magnitude than a threshold TH_mos, with TH_mos<TH_os, the system is further configured to make a tactical decision to shift the target position in order to move the follower aircraft away from the wake vortex by a distance that is equal to a predefined margin.

4. The method according to claim 3, wherein, when the assessed future overshoots become greater than or equal in magnitude to the threshold TH_os, the system is further configured to make a tactical decision to move the follower aircraft away from the wake vortex so as to place the follower aircraft at a minimum distance from the wake vortex at which an impact of the wake vortex on the follower aircraft is null.

5. The method according to claim 2, wherein, when, despite the tactical decision to move the follower aircraft away from the wake vortex so as to place the follower aircraft at a minimum distance from the wake vortex at which an impact of the wake vortex on the follower aircraft is null, the system is further configured to detect that the follower aircraft is approaching the potential discomfort window below a distance threshold TH_cr, and to make a tactical decision to perform an evasive maneuver.

6. The method according to claim 5, wherein the evasive maneuver involves diving in order to join a lower flight level.

7. The method according to claim 1, wherein each trajectory is determined by the following steps:
time discretization of the trajectory according to a predefined time step, by assessing a total available prediction time corresponding to a time that is supposed to elapse in order for the follower aircraft to substantially cover a distance corresponding to the wake vortex already formed between the leader aircraft and a current position of the follower aircraft to be considered, so as to define iterative microcycles;
and, for each iterative microcycle:
predicting a future state of the follower aircraft from a current state of the follower aircraft and modelling of the follower aircraft;
predicting a position of the follower aircraft relative to a geodetic reference frame; and
predicting positions of the follower aircraft relative to the wake vortex and law feedback.

8. The method according to claim 1, wherein the estimated position of the wake vortex and the estimation uncertainty concerning the estimated position of the wake vortex are determined using a recursive Bayesian filter.

9. A system for assisting in a formation flight of aircraft, the system comprising:
electronic circuitry configured to be placed on board an aircraft acting as a follower aircraft, the electronic circuitry configured to:
acquire information relating to a leader aircraft generating a wake vortex inducing an upward airflow;
determine an effect of the wake vortex experienced by the follower aircraft as a difference between measurements, taken by sensors of the follower aircraft, and modelling of the follower aircraft in a wake vortex-free environment;
determine an estimated position of the wake vortex from the acquired information relating to the leader aircraft and from a wake vortex model, and determine an estimation uncertainty around the estimated position of the wake vortex from the determined effect of the wake vortex experienced by the follower aircraft;
determine trajectories comprising:
a first trajectory, followed by the follower aircraft, as a trajectory for approaching and tracking the wake vortex, so as to seek to benefit from the upward airflow induced by the wake vortex, while remaining outside a potential discomfort window defined by an estimation uncertainty around the estimated position of the wake vortex, and
a second trajectory corresponding to a phantom aircraft representing the follower aircraft permanently in an optimal position relative to the wake vortex, the optimal position comprising a placement of the follower aircraft at a predefined distance from the estimated position of the wake vortex when allowed by dimensions of the potential discomfort window, and otherwise at a predefined margin from the potential discomfort window;
assessing, with respect to the second trajectory, future overshoots of the phantom aircraft relative to maneuvering capabilities of the follower aircraft and to passenger comfort rules; and
modifying the first trajectory as a function of the assessed future overshoots.
